(19) United States
(12) Patent Application Publication
(10) Pub. No.: US 2005/0266866 A1
(43) Pub. Date: Dec. 1, 2005

(54) Feature finding assistant on a user interface

(75) Inventors: Deepak P. Ahya, Plantation, FL (US); Daniel A. Baudino, Lake Worth, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 10/854,087

(22) Filed: May 26, 2004

(51) Int. Cl. H04B 15/00

(52) U.S. Cl. 455/502

(57) ABSTRACT

A method (300) of advising a user using a user interface can include tracking (302) of a number of times an event occurs during a given time, tracking (304) the time between user initiated events, generating (306) a pattern from the tracking steps, generating (308) a profile that can change dynamically as the pattern changes, detecting (310) a need for advice from the pattern, and presenting (314) advice to the user in response to the need. The method can further associate (307) the pattern with a user profile and detect from the user profile a more efficient pattern. Note, the step of detecting can be done by detecting any number of scenarios including a hesitation in menu navigation, an unsuccessful search pattern, or a varying speed traversal through different menu portions. The detecting step can also include detecting a lack of usage of a given application.

### CROSS-REFERENCE TO RELATED APPLICATIONS

See Docket No. 7463-52 and 7463-53 concurrently filed herewith.

This invention relates generally to user interfaces, and more particularly to a method and system for assisting a user to more efficiently use a user interface (UI) and applications.

### BACKGROUND OF THE INVENTION

As mobile devices and other electronic appliances become increasingly feature rich, their respective user interfaces are getting more complex. Marketing studies have indicated that approximately 90% of the users seem to be using 10% of the features available. Part of the blame can be placed on the complexity of the overall user interface and more specifically because users get lost in the Main Menu or Application Menus. Since many products today are designed to satisfy the needs of many, an inordinate amount of logical options are provided for Main menus and Application menus. Unfortunately, the numerous options result in a significant number of key presses or steps for all users. Furthermore, this results in many applications and features going unused due to a lack of easy access or guidance.

Existing UIs use soft/hot keys to allow a user a direct link to some applications. The existing soft/hot keys are sometimes user programmable, but remain static once programmed by the user. The soft/hot keys help the user to reduce the number of keystrokes to execute a desired application and to optimize the UI based on the features/applications available and their intended use. Unfortunately, since existing soft/hot key features are static, no consideration is given by the soft/hot key function to the context in which a user is currently operating a device. What may have been a desired link or hot key at one instant in time, place or application, may very well change as a result of use of a device at a different time, place or application. Existing hot/soft keys features fail to provide a dynamically changing hot/soft key function based on changing context. Existing hot/soft key functions also fail to account for a user's habits in traversing through application menus, submenus and the like. Further, once the hot/soft keys are established, there is no assistance provided and no tracking of the use of these easy access links (hot/soft keys).

Although there are systems that change computer user interfaces based on context, such schemes use limited templates that are predefined and fail to learn from a user's habits to re-organized menus (as well as submenus and application menus) and fail to provide smart assist messages. In yet other existing systems by Microsoft Corporation for example, task models are used to help computer users complete tasks such as Microsoft help/assistant, which does not have any information on the user's competence or usage. In this scheme, tasks are viewed in a macro sense such as writing a letter. User inputs are collected in the form of tasks that are then logged and formatted in a such a way (adds a parameter) that they can be parsed into clusters (similar tasks). The application uses this information to complete tasks or provide targeted advertisement. Again, such systems fail to learn from a user's habits and fail to provide smart assist messages. In yet another scheme, a teaching agent that “learns” and provides an advisory style (as oppose to assistant style) help agent exists. The agent is a computer program which simulates a human being and what another human being would do. Such a system fails to analyze a user's work as it is deemed computationally impractical if such a system tries to learn or understand semantics. It breaks down users into experts, intermediate and novice. The user background is stored in adaptive frames. The system learns about user competency based on adaptive frames information. In a nutshell, such a system focuses on modeling a user to understand the competency level so pre-programmed advisory style help can be provided (e.g. appropriate level of examples, guidance on goal achievement etc.) Such a system uses a competence assessment to go to pre-programmed messages and examples. Such a system fails to focus on understanding where a user has been in the past and what are the likely places he/she might be going. Furthermore, the users habits such as hesitation and other actions are not taken into consideration to provide smart pop ups.

### SUMMARY OF THE INVENTION

Embodiments in accordance with the present invention provide a method and system for a learning user interface framework that can include an event tracker, a time and a pattern/profile generator in an effort to provide intelligent advice regarding menu traversals and application selections.

In a first embodiment of the present invention, a method of advising a user using a user interface can include the steps of tracking a sequence of events initiated by a user on a device having a user interface and at least one application, tracking the number of times an event occurs during a given time, and tracking the time between user initiated events. Such tracking steps can include tracking usage of the user interface at different times, dates, and locations. The method can further include the steps of generating a pattern from the tracking steps, detecting a need for advice from the pattern, and presenting advice to the user in response to the need for advice. The method can further include the step of associating the pattern with a user profile and detecting from the user profile a more efficient pattern. Note, the step of detecting can be done by detecting any number of scenarios including a hesitation between applications, a hesitation on menu navigation, a predetermined time elapsed on each screen, a repeated traversal between applications, and a repeated sequence of selections without full execution of a last step, an unsuccessful search pattern, a fast traversal on a portion of a menu followed by a slow traversal in an another portion of the menu. The step of detecting can also include detecting a lack of usage of a given application, particularly a given application that can be useful to the user as determined by the user profile. Also note that advice can be presented to the user by using pop-up messages to the user.

In a second embodiment of the present invention, a dynamically enhanced user interface having configurable options such as hot/soft keys in a menu can include an event tracker, a time tracker, and a user pattern profile generator receiving inputs from the event tracker and the time tracker to generate a dynamic user pattern profile in response to the inputs from the event tracker and time tracker. Optionally, other trackers can be used such as a time of day tracker or an environmental tracker (such as a light sensor, weather sensor, biometric sensor, or location sensor) that also provides inputs to the user pattern profile generator. The user interface can further include a user assistance generator for detecting problem scenarios in the dynamic user pattern profile and generating a smart tip as well as a presentation device such as a display (or speaker) for presenting the smart tip to a user. The user assistance generator can monitor the dynamic user pattern profile and suggest improvements in usage to a user. The user interface can also include a configurable option manager that dynamically changes the configurable options such as hot/soft keys on the menu based on changes to the user pattern profile. Other configurable options can include menus, shortcuts, quick links, or any other configurable option on a main menu on a user interface, a sub-menu on a user interface, a menu for an application, or a sub-menu for an application. The user interface can further include a problem scenario database that is compared with the dynamic user pattern profile to enable the user assistance generator to detect problem scenarios and provide a corresponding smart tip.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a block diagram of a learning user interface (UI) framework or architecture in accordance with an embodiment of the present invention.

FIG. 2 is a block diagram of a learning UI module in accordance with an embodiment of the present invention.

FIG. 3 is an application tree diagram illustrating user behavior by showing menu or application traversal patterns in accordance with an embodiment of the present invention.

FIG. 4 is a user interface having a pop-up smart tip in accordance with an embodiment of the present invention.

FIG. 5 is a more specific application tree diagram corresponding to the application tree diagram of FIG. 3.

FIG. 6 is a menu selection pattern indicating a need for advice in accordance with an embodiment of the present invention.

FIG. 7 is a user interface having a pop-up smart tip providing advice for a user exhibiting behavior indicated in FIG. 6 in accordance with an embodiment of the present invention.

FIG. 8 is another user interface having smart tips providing advice for a user exhibiting behavior indicative of being lost in accordance with an embodiment of the present invention.

FIG. 9 is a flow chart illustrating a method of a method of advising a user using a user interface in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

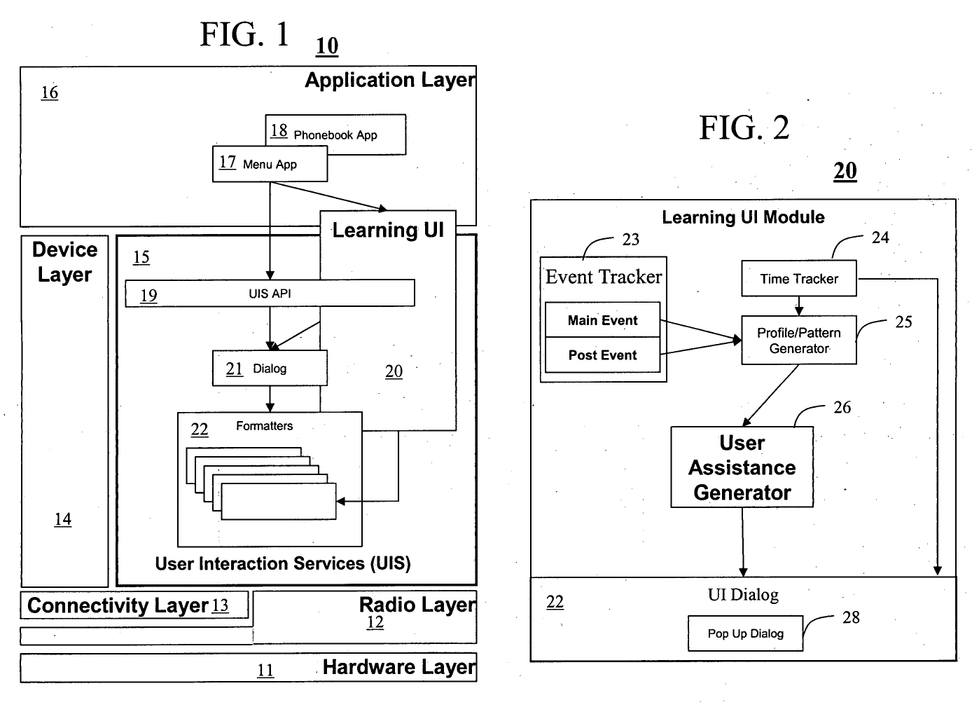

A method of arranging configurable options such as hot/soft keys in a menu can include a learning user interface architecture 10 as illustrated in FIG. 1. The architecture 10 is suitable for most electronic appliances and particularly for mobile devices although desktop appliances can equally benefit from the concepts herein. The architecture 10 can include a hardware layer 11 and a radio layer 12 as well as an optional connectivity layer 13. The architecture 10 can further include a device layer 14 that can include a user interaction services (UIS) module 15. The device layer 14 can define the functions and interactions that a particular device such as a cellular phone, laptop computer, personal digital assistant, MP3 player or other device might have with the remainder of the architecture. More likely, the UIS module 15 can be a separate module interacting responsively to the device layer 14 and other layers in the architecture 10. The architecture 10 can further include an application layer 16 that can include one or more applications such as a menu application 17 and a phonebook application 18 as examples.

The UIS module 15 can include a UIS application programming interface (API) 19 and a Learning User Interface (UI) module 20 that receives inputs from the application layer 16. The UIS API 19 and the Learning UI module 20 can provide inputs to a dialog block 21. The dialog block 21 and the Learning UI can also correspondingly provide inputs to a dialog formatter 22.

Referring to FIGS. 1 and 2, the dialog block 21 can provide a user with assistance in various forms using a pop-up dialog 28 for example via the dialog formatter 22. Referring to FIG. 2, the Learning UI module 20 can include an event tracker 23, a time tracker 24, a profile/pattern generator 25, and a user assistant generator 26. The event tracker 23 can record key sequences, UI Start and end events (actions), applications launched, and other events. The event tracker can track a main event such as the launch of an application and then track subsequent events such as the user's traversal through menu and sub-menu selections within the application. The time tracker 24 can include a macroscopic and a microscopic time monitor. The macroscopic time module monitors the number of times a particular event pattern occurs within a given time whereas the microscopic time module detects the gap or elapsed time between key presses. The microscopic time module enables the detection of pauses between key presses. The time tracker 24 is primarily used to detect when and how often the events occurred.

The pattern/profile generator 25 records the behavior of the user on time and can use the information from the tracking modules mentioned above to process them to produce patterns, and associations creating a unique profile for a user based on patterns detected. The user behavior can include how, when and where applications are launched, how long the applications are used, intervals between usages and other user behavior patterns. The user assistance generator 26 detects certain patterns from the user profile generated by the pattern/profile generator 25. Using the framework described above, the system can detect, among other things, an unsuccessful search pattern, a hesitation on menu navigation (hesitation time corresponds to confusion), a time elapsed on each screen, a fast traversal on part of the menu (experienced user) followed by a slow traversal indicating difficulty obtaining a desired application, feature or function.

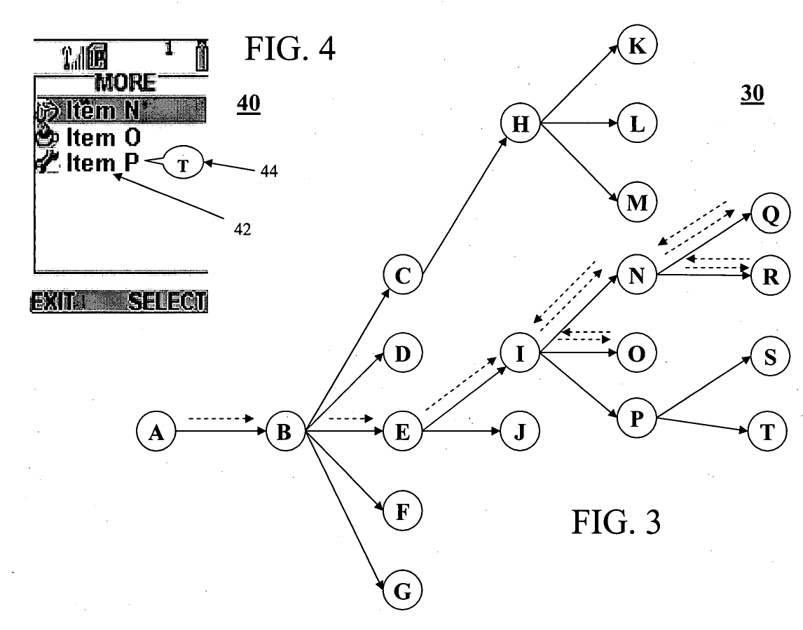

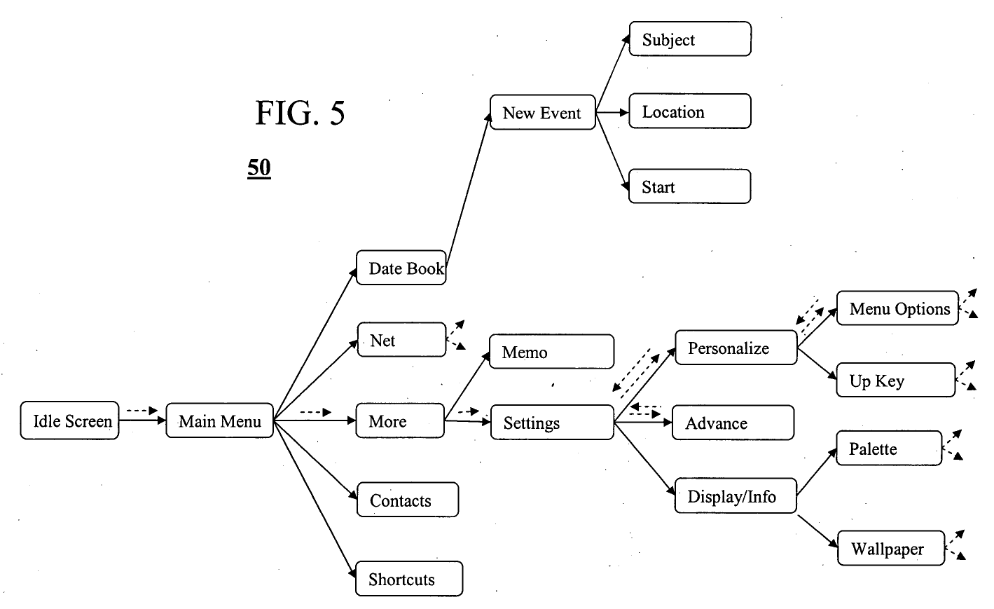

With reference to the generic application tree 30 of FIG. 3 and the user interface 40 of FIG. 4 as well as the more specific application tree 50 of FIG. 5, an example pattern can be identified as:
(A-B-E-I-N-Q-^{(Back)}-NR-^{(Back)}_{-N-I-O-}^{(Back)}-I... ....)
   The particular corresponding pattern identified in FIG. 5 is:
(Idle Screen-Main Menu-More-Settings-Personalize-Menu-Options-^{(Back)}-Personalize-Up Key^{(Back)} Personalize-Settings-Advance-^{(Back)} Settings.. ...)
   In such a scenario, it can easily be identified that the user is lost or forgot the path to a desired application. If the user previously accessed “T” or “Wallpaper”, a quick tip or pop-up dialog 44 can be displayed on the user interface 40 next to an item “P” or “Display/Info” 42 which will easily lead the user to the desired application. Generating such messages can allow users to find applications much more easily which would otherwise likely remain unused or rarely used. This is particularly useful in the scenario where the option “T” or “Wallpaper” was previously used frequently, but was not used in a while. The system detects this pattern as an indication that the user fails to remember where the “T” or “Wallpaper” function is located.

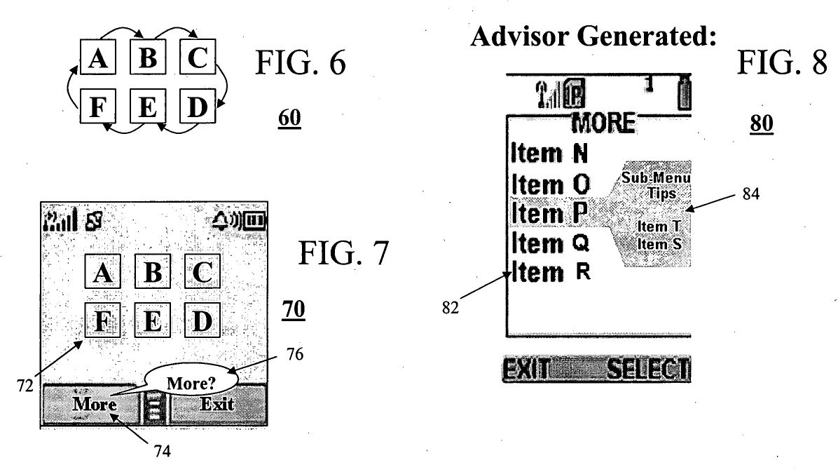

Referring to FIG. 6, another example illustrates a pattern indicative that the user is lost. The pattern detected is A-B-C-D-E-F, that tells the system that the user is going in circles in a menu. As illustrated in a user interface 70 of FIG. 7, a user that scrolls in a circular pattern among items 72 available on a main menu might not realize that more options are available by activating a “more” item or function 74. The function 74 can be highlighted with a pop-up dialog 76 or highlighted in other ways including, but not limited to, bolding, changing colors, or flashing the item 74 in order to obtain the user's attention.

Another example as illustrated by the user interface 80 of FIG. 8 can show a detected pattern of:
N-O-P-^{(Pause)}-Q-R-^{(Pause)}-Q-P-O-N.
   The time between applications can be recorded providing a pattern indicating a pause on some options 82. The pause can be an indication that the user is lost. As a result, the system can provide sub-menu tips 84 such as an indication that items “S” and “T” are sub-items under item “P”.

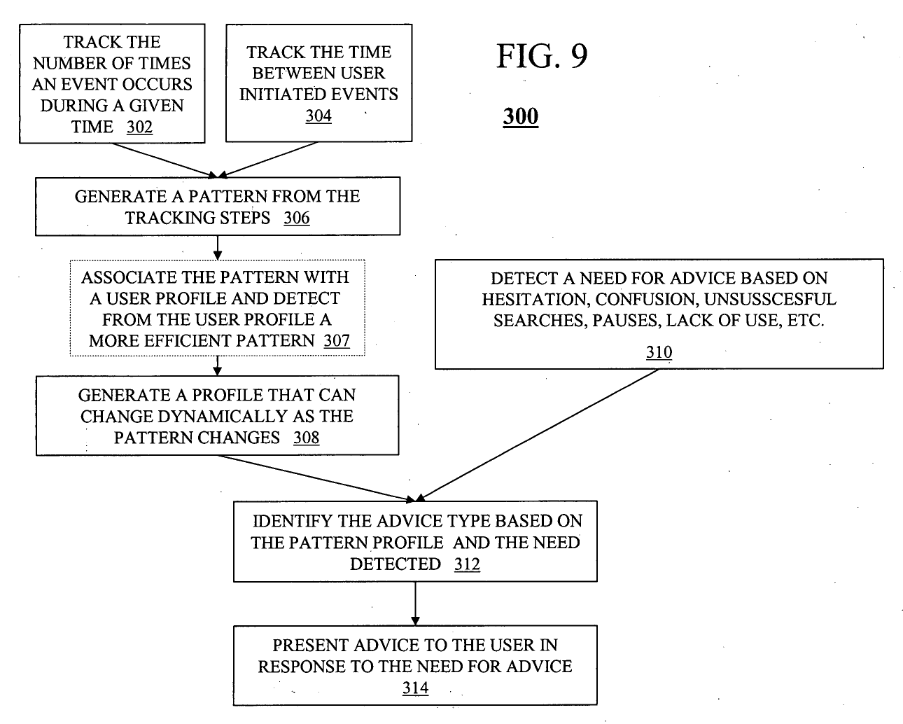

Referring to FIG. 9, a flow chart illustrating a method 300 of advising a user using a user interface can include the step 302 of tracking the number of times an event occurs during a given time and tracking the time between user initiated events at step 304. Such tracking steps can include tracking usage of the user interface at different times, dates, and locations. The method can further include the step 306 of generating a pattern from the tracking steps and generating a profile that can change dynamically as the pattern changes at step 308. Optionally, at step 307, the method can associate the pattern with a user profile and detect from the user profile a more efficient pattern. Alternatively or optionally, the method can also include the step of detecting a need for advice based on user hesitation, confusion, unsuccessful searches, pauses, etc., at step 310. At step 312, the method can then identify the advice type based on the pattern profile and the need detected from step 308 and 310. The advice can then be presented to the user in response to the need for advice at step 314. Note once again that the step of detecting can be done by detecting any number of scenarios including a hesitation between applications, a hesitation on menu navigation, a predetermined time elapsed on each screen, a repeated traversal between applications, and a repeated sequence of selections without full execution of a last step, an unsuccessful search pattern, a fast traversal on a portion of a menu followed by a slow traversal in an another portion of the menu. The step of detecting can also include detecting a lack of usage of a given application, particularly a given application that can be useful to the user as determined by the user profile. Also note that advice can be presented to the user by using pop-up messages to the user.

In light of the foregoing description, it should also be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

1. A method of advising a user using a user interface, comprising the steps of:
tracking a sequence of events initiated by a user on a device having a user interface and at least one application;
tracking the number of times an event occurs during a given time tracking the time between user initiated events;
generating a pattern from the tracking steps;
detecting a need for advice from the pattern; and
presenting advice to the user in response to the need for advice.

2. The method of claim 1, wherein the method further comprises the step of associating the pattern with a user profile and detecting from the user profile a more efficient pattern.

3. The method of claim 1, wherein the method further comprises the step of tracking usage of the user interface at different times, dates, and locations.

4. The method of claim 1, wherein the step of detecting the need comprises at least one among the step of detecting a hesitation between applications, a hesitation on menu navigation, a predetermined time elapsed on each screen, a repeated traversal between applications, and a repeated sequence of selections without full execution of a last step, an unsuccessful search pattern, and a fast traversal on a portion of a menu followed by a slow traversal in an another portion of the menu.

5. The method of claim 1, wherein the step of detecting the need comprises the step of detecting a lack of usage of a given application.

6. The method of claim 5, wherein the method further comprises the step of advising in a pop-up message to the user of the lack of usage of the given application.

7. The method of claim 1, wherein the step of presenting advice comprises the step of displaying a pop-up dialog on the user interface providing the advice.

8. A dynamically enhanced user interface having configurable options, comprising:
an event tracker;
a time tracker;
a user pattern profile generator receiving inputs from the event tracker and the time tracker generating a dynamic user pattern profile in response to said inputs;
a user assistance generator for detecting problem scenarios in the dynamic user pattern profile and generating a smart tip; and
a presentation device for presenting the smart tip to a user.

9. The user interface of claim 8, wherein the user interface further comprises a configurable options manager that dynamically changes the hot/soft keys on the menu based on changes to the user pattern profile.

10. The user interface of claim 8, wherein the configurable options comprises hot/soft keys in a menu.

11. The user interface of claim 8, wherein the configurable options comprises at least one among menus, shortcuts, quick links, or any other configurable option on a main menu on a user interface, a sub-menu on a user interface, a menu for an application, or a sub-menu for an application.

12. The user interface of claim 8, wherein the user assistance generator monitors the dynamic user pattern profile and suggests improvements in usage to a user.

13. The user interface of claim 8, wherein the presentation device comprises a display.

14. The user interface of claim 8, wherein the user interface further comprises a problem scenario database that is compared with the dynamic user pattern profile to enable the user assistance generator to detect problem scenarios and provide a corresponding smart tip.

15. A machine readable storage, having stored thereon a computer program having a plurality of code sections executable by a machine for causing the machine to perform the steps of:
tracking a sequence of events initiated by a user on a device having a user interface and at least one application;
tracking the number of times an event occurs during a given time tracking the time between user initiated events;
generating a pattern from the tracking steps;
detecting a need for advice from the pattern; and
presenting advice to the user in response to the need for advice.

16. The machine readable storage of claim 15, wherein the machine readable storage is further programmed to cause the machine to associate the pattern with a user profile and detecting from the user profile a more efficient pattern.

17. The machine readable storage of claim 15, wherein the machine readable storage is further programmed to cause the machine to detect the need for advice by detecting at least one among a hesitation between applications, a hesitation on menu navigation, a predetermined time elapsed on each screen, a repeated traversal between applications, a repeated sequence of selections without full execution of a last step, an unsuccessful search pattern, and a fast traversal on a portion of a menu followed by a slow traversal in an another portion of the menu.

18. The machine readable storage of claim 15, wherein the machine readable storage is further programmed to cause the machine to detect the need for advice by detecting a lack of usage of a given application.

19. The machine readable storage of claim 15, wherein the machine readable storage is further programmed to cause the machine to present advice by displaying a pop-up dialog on the user interface providing the advice.
